(19) United States
(12) Patent Application Publication
(10) Pub. No.: US 2017/0249653 A1
(43) Pub. Date: Aug. 31, 2017

(54) SYSTEM AND METHOD FOR PROVIDING TRANSPORTATION OR OTHER ACTIVITY BASED OFFERS

(71) Applicant: Natasa KARAMBATSOS, Brossard (CA)

(72) Inventor: Natasa KARAMBATSOS, Brossard (CA)

(21) Appl. No.: 15/511,002

(22) PCT Filed: Jun. 5, 2015
(86) PCT No.: PCT/CA2015/000359

§ 371 Date: Mar. 13, 2017

Related U.S. Application Data
(60) Provisional application No. 62/085,482, filed on Nov. 28, 2014.

(51) Int. Cl. G06Q 30/02

(52) U.S. Cl. CPC G06Q 30/0211; G06Q 30/0226; G06Q 30/0236; G06Q 30/0233; G06Q 30/0234

(57) ABSTRACT

A system and method for providing a consumer with at least one merchant offer. The method comprises identifying an end destination of the consumer, the end destination having an associated activity and activity cost, providing to the consumer the at least one merchant offer based on the end destination, the at least one merchant offer having an associated reward and an associated conversion ratio, prompting the consumer to select one of the provided at least one merchant offer and upon proof of fulfilment of the activity and disbursement in goods and/or services of the merchant by the consumer greater or equal to the activity cost multiplied by the conversion ratio of the selected merchant offer, providing the reward associated with the selected merchant offer to the consumer.

### CROSS-REFERENCE TO RELATED APPLICATIONS

This application claims the benefits of U.S. provisional patent application No. 62/085,482 filed on Nov. 28, 2014, which is herein incorporated by reference.

### TECHNICAL FIELD

The present disclosure relates to a system and method for providing transportation or other activity based offers and more particularly offers such as discounts, reward points, goods, services, gift certificates, etc. in relation to goods and/or services of a merchant.

### BACKGROUND

It is well known that merchants experience the problem of business surplus to varying degrees. The expression “business surplus” refers to any supply of assets or capacity which exceeds the demand for same.

For merchants that sell goods, business surplus is generally experienced in the form of excess inventory. It can include excess inventory such as overstocks, consumer returns, discontinued items and obsolete inventory (which refers to items which are no longer in season, have expired or are outdated for the purposes of a business).

For merchants that sell services, business surplus is generally experienced in the form of idle capacity. This refers to an economic situation in which the market will not absorb all of the maximum possible output possible for a provider, at a price exceeding the variable cost of production. For example, the seats which are both unsold and unoccupied at the time of a concert or sports event represent a form of idle capacity. It is estimated that in the U.S., more than 25% of tickets to large venue or arena shows or events do not sell. If prices are too high, unsold tickets result in idle capacity (unoccupied seats through unsold tickets). If prices are too low, this contributes to a legal secondary market totaling in excess of approximately $3 billion. This remains true despite the fractured system of online ticket merchant sales sites that have developed in response to the need for merchants to liquidate available surplus capacity.

It is a per se industry reality that certain periods of a daily, monthly, weekly or seasonal cycle will be less occupied than others in connection with both the sale of goods and the sale of services.

These cycles can occur on or during, for example, (i) specific hours (for example, the period between 2 p.m. to 4 p.m., which Is traditionally less busy for food service establishments than the period between 6 p.m. and 8 p.m.); (ii) days of week (for example, Monday is traditionally less busy than Saturday for hair salons); (iii) seasonal cycles (for example, December is traditionally a busier month than January for retail merchants); and/or (iv) specific holidays (for example, Thanksgiving is traditionally less busy for food service establishments than Valentine's Day). This is experienced by a broad number of commercial establishments of all nature and kinds, including without limitation, hotels, restaurants, bars, theaters, cinemas, sports venues, retailers, big box chains, hair salons, service providers, and others. The merchants that own and/or operate of such commercial establishments (including any of their respective lessors, licensors, licensees, franchisors, franchisees and/or authorized representatives) are sometimes required to keep their establishments open during periods which are not profitable—at times, even operating at a loss where operating costs exceed earnings in a given period of time (for example, to comply with lease covenants or to provide key personnel sufficient work hours to avoid unwanted departures). Many such merchants, moreover, want to limit weakening or diluting their brand and avoid creating the impression that the commercial establishment is less competitive than similar establishments.

To address the aforesaid problems, some merchants have tried to attract consumers by providing them with discounts, coupons, vouchers, offers, rewards, incentives (such as, for example, loyalty, points, and reward cards, systems and programs) and promotions. An example of such a program includes group sales sites, daily deal sites and flash sales sites, amongst others (collectively referred to hereafter as discounting sites) pursuant to which merchants pre-sell goods and/or services at highly discounted rates. While successful for some merchants, this course of action is not appropriate for most merchants.

There are several reasons for this, core to which is that the problem of excess inventory experienced by a seller of goods is different from the problem of idle capacity experienced by a seller of services. This difference conditions different methods of resolution. A key distinction lies in the ability of each of the seller of goods and the seller of services to predict and control supply-side processes. A sports retailer (seller of goods) who has 20 tennis rackets in stock knows at the end of each sale how many tennis rackets in stock it has available and can sell at any given time. It has a readily assessable quantification of its inventory and its availability. If this inventory begins to run low, such vendor of goods can place an order with a supplier for additional tennis rackets and replenish this stock. In contrast, how long it takes for a table in a restaurant (seller of services) to be available for a second seating depends on factors which can be as varied, for example, as the nature of the order (for example, a well-cooked steak takes longer to prepare and serve than a sandwich); the size of the group (for example, a larger party may occupy its table longer than a person dining alone); the occasion being celebrated (for example, a couple celebrating their anniversary is likely to take longer than two colleagues who wish to dine quickly over lunch); to the amount of liquor consumed. The ability of the service provider in this case to replenish inventory is also more restricted. Even if it had more food, more tables and chairs, the availability of an in-dining experience is subject to restrictions of space. In sum, availability of supply is generally a more dynamic and less predictable process in the context of service provision than in the context of goods provision. Note that while exceptions are present (for example, goods sold in an art auction) the foregoing distinction can globally be observed between primarily goods-oriented vendors and primarily service-oriented vendors.

However, discount site offers (such as, for example, group pre-paid vouchers) are static because the period of redemption is generally broad, with limited ability by merchant to revoke the offer once purchases of vouchers have been made by consumers. Discount site offers are also largely agnostic to merchant capacity at the moment during which a consumer visits a merchant establishment to redeem an offer so long as it is within a single large and fixed framework of time (ex. “180 days to redeem an offer”). However, as we have seen, idle capacity of a merchant is only corrected if the number of discount holders who present themselves at any given time do not exceed the capacity which a merchant could not otherwise monetize on a non-discounted basis at such moment in time.

It becomes quickly apparent from the above that simply providing a static offer over a large period of time during which a consumer can “redeem an offer” (ex. 90 to 180 days) does not correct the problem of the merchant looking to optimize idle capacity, which fluctuates in hourly, daily and weekly cycles. For example, if 100 Groupon vouchers are sold for a restaurant, the restaurant is only resolving its business surplus (manifesting in the form of idle capacity) if the number of consumers presenting on the premises at any given time does not exceed to the number of seats that are not or cannot foreseeably be occupied by consumers paying full price. If those same 100 voucher holders all show up on a night when the restaurant can fill its seats with consumers paying non-discounted prices, then that same group deal is not optimizing idle capacity: it is toxic to the profit margin of the Merchant.

Moreover, as illustrated hereinabove, the objective of resolving idle capacity requires for its accomplishment not only that the total capacity of a merchant's asset be used, but that this be achieve it in a way which optimizes earnings of such merchant. This optimization can be increased by providing the merchant with increased opportunity to assign capacity to a non-discount consumer instead of a discount consumer. One way to achieve this outcome is to time issuance and redemption of offers closely to minimize the number of consumers presenting to the merchant with discount offers, and allow for dynamic configuration of deal parameters by the merchants.

The concept of a bulk period of “90 to 180 days” to redeem an offer is retail sales thinking, imported to the service industry. Availability of capacity is dynamic, whereas offer redemption parameters are generally static. However, a solution to excess inventory is not a solution to idle capacity. For a discount offer to correct the problem of idle capacity, it must be presented at a time when idle capacity exists, which is itself in constant flux. Consequently, absent the ability by the merchant to control the moment of redemption of a consumer offer—and not merely the moment issuance of the consumer offer—discounting sites are definitionally not correcting the primary problem of service providers in the most optimal manner.

Moreover, current discount sites present additional challenges to merchants.

First, there may be reticence on the part of merchants to engage in such practices based on a variety of reasons, including: (i) cultural or personal biases; (ii) legal restrictions imposed under licensing, franchise and/or leasing agreements; (Iii) the risk of brand dilution; and (iv) concerns associated with peer, sponsor, partner, consumer, employee or investor perceptions, actual or prospective, that a business is experiencing financial difficulties. By way of example, an employment candidate looking to work for one of two merchants may be less inclined to work for one which repeatedly discounts the costs of services, as opposed to one which does not.

Discounting the price of a brand causes that brand to become susceptible to a reduction in perceived value by the consumer. This reduced perception of brand value is referred to as brand dilution. The question is whether there is a way to grant an identical economic benefit to consumers in such a way as to better insulate merchants from brand dilution? The answer is affirmative: an economic benefit represented as a gift to the consumer impacts differently on brand perception than an identical economic benefit which is structured as a discounting of offerings. By way of example, the Four Seasons Hotel can sell a Niçoise Salad for $30. If it were to sell vouchers on Groupon letting a consumer purchase this same salad for $20, it would suffer a net reduction in brand prestige. However, if it agreed instead to redeem a $10 valet parking ticket, it would manage to provide an identical $10 discount to the consumer without suffering brand prestige. However, even though the effective price of the salad is $20 in both cases, it is clear that couponing presents materially less appeal to a high-end establishment than providing a gift of analogous value (in this example, by way of valet parking redemption).

Offering value to consumers in a way that relates to their transportation (such as valet parking) minimizes brand dilution when compared to a merchant strategy that involves selling or giving coupons or discount vouchers. If private vehicle ownership and usage is in decline, there is reason to believe that providing an economic consumer value related to new or alternative modes of transportation in order to reward his or her patronage of an establishment, would have the effect of taking an already strong and novel solution which resolves challenges associated with business surplus, with limited adverse impact on brand dilution.

Second, the nature of the consumers that traditional coupons and discounts attract is frequently a source of concern for merchants. The objective of many, though not all, merchants in discounting their respective products and services on a limited basis by way of such promotional discounts is to secure repeat consumers. However, there exists a concern prevalent amongst merchants that such promotions attract a higher number of so-called “bargain hunters” than their establishment would otherwise attract, who themselves present poor ongoing-demand prospects for the merchant in question barring such discounting.

Thirdly, there is an issue associated with timing of both the issuance of a discount offer, and the redemption of such offer. For example, a restaurant may offer a substantial discount on Groupon™ to 500 individuals. Each of these individuals has paid $10 to purchase a voucher having a face value of $20 via Groupon™, which voucher can be redeemed at any time during the 180-day period immediately following the date of purchase of such voucher. Groupon retains one half of the amount collected from the purchasers of such vouchers. However, one week later the restaurant may have been written up positively in the New York Times. The restaurant is now left having to book tables for 500 individual voucher-holders, thereby earning 75% less in revenues than it would have earned if those same tables were free for the restaurant in question to allocate to existing or prospective non-voucher holding consumers paying full price.

The above example underscores several problems with existing solutions. The first is that it is difficult for merchants to control the moment of redemption under available tools at a microlevel (specific hours, days or occasions). An example of this is the average crowd-sourced model utilized by Groupon™. This model is generally premised on the pre-purchase by a consumer of a product or service at a fixed and reduced price in advance of obtaining such product or service. A weakness in the model is that there are only a fraction of such cases where the moment of redemption can be limited to isolated times of day, days, or occasions. Moreover, if the period during which a discount can be applied or a voucher redeemed is too narrow, then individuals lose interest. However, if such period of time is broadened, the merchant is left managing an influx of consumers, which all wish to obtain products and services at a discount rate and may do so at times which generate an opportunity cost to the merchant.

For example, a hair salon that has sold 500 vouchers on Groupon™ for haircuts may not indicate in the terms and conditions of such voucher, which itself expires in 90 days, that appointments using such voucher cannot be made on Friday or Saturday. It is foreseeable that a number of prospective buyers would not be interested in the service if they cannot have their hair styled on such days. In this scenario, the salon in question may instruct its staff on an internal basis not to offer scheduling on a Friday or Saturday—but the fact remains that it must necessarily find a way to schedule 500 discounted appointments in a finite amount of time—in this case, 90 days. Necessarily, there will be appointments made by voucher holders that the salon will be obligated to accept on days when it would have otherwise been able to procure identical services to a consumer paying full-price; the latter which the salon will have to refuse to the extent the salon has allocated its available personnel to one or more discount consumers. Consequently, there exists, in addition to the risk that a discount will cause the cost of a service to be insufficient to cover its cost, a risk to merchants associated with contingent and actualized opportunity costs.

Fourthly, the provision of discounts and associated marketing is a speculative exercise for a significant number of merchants as a result of the underlying economic sequence of the discount model. Traditional advertising models often contemplate a situation where a marketing expense is made, and the return on investment from this marketing expense (also known as ROI) is only fully known by the merchant after it has effected such spend. For example, if a merchant pays amount $100 to publish an advertisement in a newspaper, but fails to generate a financial return of more than half of amount $100 as a direct or indirect result of this expense, the advertisement in question represents a failed customer acquisition initiative. In contrast, the group offer discount model often purports to offer to merchants the reverse: the opportunity to know their ROI from a marketing expense, before such spend is effected by the merchant in question. In this case, the cost to such merchant of making the goods and services available at a discount on a group deal website represents a form of marketing expense for merchants. However, the reality is that the ROI to a merchant resulting from issuing such offers cannot in the majority of cases be objectively established by such merchant before it issues a group discount offer. The reason concerns the method of calculation of ROI. A return on investment (ROI) measures the ratio of profits to advertising costs. However, profits are directly conditioned by the number of consumers who redeem or do not redeem their offers. This is known as a breakage rate. Specifically, the number of unredeemed vouchers can only be known on the earlier of the expiration of the redemption period or the date upon which all the vouchers are redeemed. Because it Is only subsequent to the offer issuance that the breakage rate can be established, which Itself directly conditions the profitability of the offer, the ROI cannot be known by a merchant until a period of; because it is only at such time that the breakage rate, which conditions the profit assessment under an ROI calculation, can be known.

Separately, the effective consumer acquisition cost (CAC) of a merchant is difficult to establish in advance of any offer issuance. The CAC corresponds to the cost of a merchant to acquire a customer. It can include the cost incurred by a merchant to provide a specific discount or promotion to a consumer in relation to one or more goods and/or services, or in providing advertising and marketing in relation to same.

Currently, merchants that provide group discounts, discounted vouchers and similar promotions do so hoping in many cases that the cost they incur to do so will yield at least a minimum return on investment (ROI) which exceeds the costs they incurred to make such promotions available. However, a major problem with the discount model is that a merchant often does not know from the outset if the cost it incurs by providing specific discounts of its products or services will actually yield the return on investment it expects. This is particularly true if the discount on a product or service offered by a merchant is so substantial, or the revenue share arrangement with the entity brokering the discount is so significant, that the merchant can only secure a profit from the sale of discounted vouchers if it can reasonably ensure that a specific number of voucher holders will never redeem their vouchers (breakage rate), and/or will effect a minimum number of undiscounted subsequent transactions. This is highly speculative for such businesses.

There is currently no method or system available which conditions both (i) the moment of redemption or application of a discount, coupon, voucher, incentive or promotion in relation to the purchase or procurement of goods and/or services, as well as (ii) the moment of availability to individuals of such discount, coupon, voucher, incentive or promotion, by (iii) limiting both the redemption and the availability of such discount, coupon, voucher, incentive or promotion to optimal moments dynamically established and customized by a commercial establishment in a way that enables such merchant to optimally allocate its human capital and operating resources, and (iv) which limits a key risk inherent to traditional group discount models, which is that the customer acquisition cost (CAC) under such models is generally incurred before the effective return on investment (ROI) associated with such cost is realized or known (including as a result of the unknown breakage rate at the time a merchant consents to the sale of an offer) while (v) minimizing brand dilution. Thus there is a clear need for such a method or system.

### SUMMARY

There is provided a system and method for providing transportation or other activity based offers and more particularly offers such as discounts, reward points, goods, services, gift certificates, etc. in relation to goods and/or services of a merchant. Other activities may include, for example, health or goodwill related activities.

The system and method reduce the cost of advertising and expands the marketing opportunities for businesses who would otherwise not subscribe to a discount, voucher, incentive, loyalty/reward or similar campaigns. The system and method for providing transportation or other activity based offers guarantees that the cost a merchant incurs in offering discounts, vouchers, incentives or similar promotional and marketing campaigns are the object of a guaranteed minimum financial return to, transforming what was previously an actual or contingent liability into a source of revenue.

This is accomplished by providing to a consumer discounts, reward points, goods, services and gift certificates, etc., upon proof of payment of the transportation or activity cost or proof of fulfillment of the activity and then, upon the consumer effectuating a disbursement at the merchant's establishment greater or equal to the activity cost (in the case of the fulfilment of an activity, the activity cost may be a direct monetary cost, an equivalent monetary cost or an assigned monetary cost) multiplied by the conversion ratio.

Accordingly, the present disclosure provides a method for providing a consumer with at least one merchant offer, the method comprising:
identifying an end destination of the consumer, the end destination having an associated activity and activity cost;
providing to the consumer the at least one merchant offer based on the end destination, the at least one merchant offer having an associated reward and an associated conversion ratio;
prompting the consumer to select one of the provided at least one merchant offer; and
upon proof of fulfilment of the activity and disbursement in goods and/or services of the merchant by the consumer greater or equal to the activity cost multiplied by the conversion ratio of the selected merchant offer, providing the reward associated with the selected merchant offer to the consumer.

The present disclosure also provides a system for providing a consumer using a first computing device with at least one merchant offer, the system comprising:
a database;
a processor in communication with the database, the processor having a first interface for communication with the first computing device and being configured to:
   receive an end destination from the first computing device, the end destination having an associated activity and activity cost;
   display to the consumer through the first interface the at least one merchant offer from the database, the merchant offer being based on the end destination and having an associated reward and an associated conversion ratio;
   prompt the consumer through the first interface to select one of the displayed at least one merchant offer; and
   provide the selected merchant offer to the consumer.

The present disclosure further provides a system as above, wherein the processor is further configured to:
verify payment of the activity cost and disbursement in goods and/or services of the merchant by the consumer greater or equal to the activity cost multiplied by the conversion ratio of the selected merchant offer; and
provide the reward associated with the selected merchant offer to the consumer.

### BRIEF DESCRIPTION OF THE FIGURES

Embodiments of the disclosure will be described by way of examples only with reference to the accompanying drawing, in which:

FIG. 1 is a schematic view of computing devices connected to a system for providing transportation or other activity based offers through a network;

FIG. 2 is a schematic diagram of the system for providing transportation or other activity based offers in accordance with an illustrative embodiment of the present disclosure;

FIG. 3 is a flow diagram depicting the process of accessing the system for providing transportation or other activity based offers;

FIG. 4 is a flow diagram depicting the consumer interface process in accordance with an illustrative embodiment of the present disclosure;

FIG. 5 is a flow diagram depicting the merchant interface process according to an Illustrative embodiment of the present disclosure;

FIG. 6 is a flow diagram depicting the offer providing process according to an illustrative embodiment of the present disclosure; and

FIG. 7 is a schematic representation of the display by the system for providing transportation or other activity based offers of a transportation based offer search result.

Similar references used in different Figures denote similar components.

### DETAILED DESCRIPTION

Generally stated, the non-limitative illustrative embodiments of the present disclosure provide a system and method for providing transportation or other activity based offers and more particularly offers such as discounts, reward points, goods, services, gift certificates, etc. In relation to goods and/or services of a merchant (which includes any provider of goods and/or services). For concision purposes only, reference will be made to a system and method for providing transportation based offers, it is to be understood that the system and method may apply to other activities such as health and goodwill activities.

It is well known in the art of marketing that the objective of a business in incurring a cost to acquire a consumer is a financial return that minimally enables such business to offset such incurred cost Implicit in this is that a merchant will confer a value to a consumer if it can guarantee a minimum financial return as a result of conferring said value to consumer.

Under the current discount models, the cost of a merchant to acquire a customer precedes the knowledge or actualization, for the merchant, of the financial return it can expect to receive as a result of the cost of such merchant to acquire such customer. If there was a way for a merchant to guarantee a specific return on investment for each dollar it spent to acquire a customer before spending any amount, then this would cease to be a risk: the merchant would minimize its losses as a result of incurring a cost (such as offering a discount to a consumer) because the merchant would always receive a financial benefit as a result of his investment. This is accomplished by setting a minimum threshold amount needed by the merchant to offset such cost. Such threshold amount can be articulated as a multiple of the amount spent by the merchant to acquire the customer and is referred to herein as the merchant offset amount while the multiple of the amount spent to acquire the customer is referred to as the merchant offset multiple, which will hereon be referred to as the conversion ratio.

For illustrative purposes, suppose a merchant is not willing to spend more than $5 to gain a consumer unless this consumer spends at least $35 with such merchant, then it is improbable the store will refuse to spend this $5 amount to acquire a consumer if it is guaranteed, before it assumes this cost, to earn at least $35 as a result of spending such $5 to acquire the consumer. In this case, the conversion ratio is 7.0. the consumer must spend in the merchant's establishment an amount equal to at least seven times that spent by the merchant to acquire the consumer in order to benefit from an offer having a value of $5.

The method for providing transportation or other activity based offers, in the case of transportation based offers, operates such that a merchant deducts, from the price of goods and/or services to be paid by a consumer, a sum corresponding to a transportation cost incurred by the consumer, provided the consumer in question has minimally spent for such goods and/or services a sum that is equal to the transportation cost multiplied by the conversion ratio. However, the consumer must satisfy certain conditions in order to benefit from the discount provided by the transportation based offer, which are described in more detail below. Conditions may include, for example, periods of time within which the transportation based offer is made available to the consumer, and specific transportation modes (such as, for example, subway fares and taxi fares only) with respect to which a merchant is prepared to make a transportation based offer (referred to as qualified transportation modes). If the consumer fails to comply with the conditions of the transportation based offer, he/she cannot take advantage of the discount.

The transportation cost can be the cost Incurred for various transportation modes, for example limousine, taxi, for-hire vehicle, self-driving vehicle, bus, train, tram, metro, boat, ferry, hovercraft, helicopter, airplane and any other form of transportation, it may also include parking charges as well as tolls fees.

A participating merchant is a commercial establishment that has registered as a member on the system for providing transportation based offers may provide not only information such as name, address, contact Information, number and location of establishments, and the like, but also the conversion ratio, the promotion period (i.e. the time period during which the transportation based offer can be issued) and/or the redemption period (i.e. the period of time during which the transportation based offer be claimed from the merchant), whether or not the transportation based offer occurs over a recurring period of time (for example, for only one Monday or every Monday in a given year) or is limited to a specific holiday or time of day, the qualified transportation modes and additional related information which could reasonably be requested from time to time (i.e. banking information, handicap access, languages spoken and the like). It is to be understood that the system for providing transportation based offers may impose restrictions and conditions, such as, for example, that the redemption period be limited to a minimum and/or maximum term determined or that the discounts in any given day not exceed a total aggregate amount.

The system and method for providing transportation or other activity based offers reduces the difficulties and disadvantages of the prior art by allowing a consumer to consult information about one or more participating merchants near a desired location, Including the conversion ratio associated with each merchant offer, through the use of electronic platforms and mediums. By controlling the conversion ratio a merchant never has to issue an offer which does not yield a return sufficient to offset its costs.

In essence, the merchant isn't choosing which consumer it targets; the consumer is choosing which merchant it targets to do business with. This allows merchants to be busier during periods of idle latency. This in turn allows them to retain more personnel, manage personnel more effectively, increase profitability and growth, and in turn Improve taxes payable in, and reduce unemployment or underemployment rates of, cities, municipalities and regions worldwide. It does so in a way that ensures merchants who register with the system for providing transportation or other activity based offers are not issuing discount offers without a determined or determinable return for every dollar spent to provide a discount, and that such offers are being issued at optimal times that minimize destabilization of existing operations and opportunity costs of merchants.

It is to be understood that in alternative embodiments the offers may be transferrable to another consumer, i.e. the consumer redeeming the offer may not be the same one that executed the activity (e.g. traveled the end destination). Offers may be transferred, sold, auctioned, donated, exchanged, aggregated, etc.

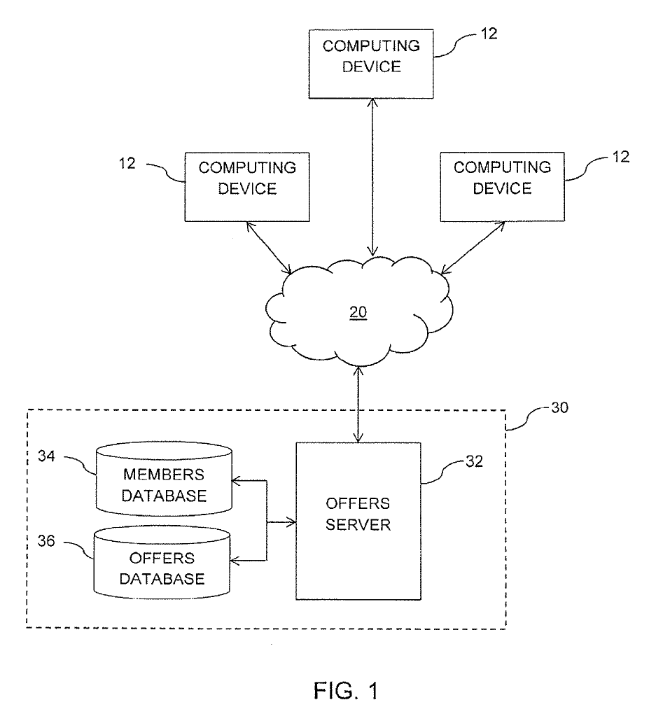

Referring to FIG. 1, users using various computing devices 12 such as, for example, a personal computer, a laptop computer, a smart phone (IPhone™, Blackberry™, etc.), tablet PC or personal digital assistant (PDA), or any other such computing device, on which runs a communication software such as, for example, a web browser or an app, may access the system for providing transportation or other activity based offers 30 via a network 20 such as, for example, Ethernet (broadband, high-speed), wireless WiFi, cable Internet, satellite connection, 3G, 4G, LTE or other cellular/mobile network, etc., or a combination thereof.

The computing device 12 may include global positioning system (OPS) functionality to determine its geographic location and orientation. The computing device 12 may also include software for determining its position based on received signals, such as signals from one or more cell phone towers, or an internet protocol (IP) address. This information may be transmitted by the computing device 12 to the system for providing transportation or other activity based offers 30 with the user's permission or automatically.

The system for providing transportation or other activity based offers 30 includes an offers server 32, a members database 34 and an offers database 36. It is to be understood that although throughout the disclosure reference is made to separate server 32 and databases 34, 36, these may be implemented on one or more physical device and/or may be combined. It is to be further understood that the members 34 and offers 36 databases may equally be implemented by a data structure within a computer memory, such as the memory of offers server 32.

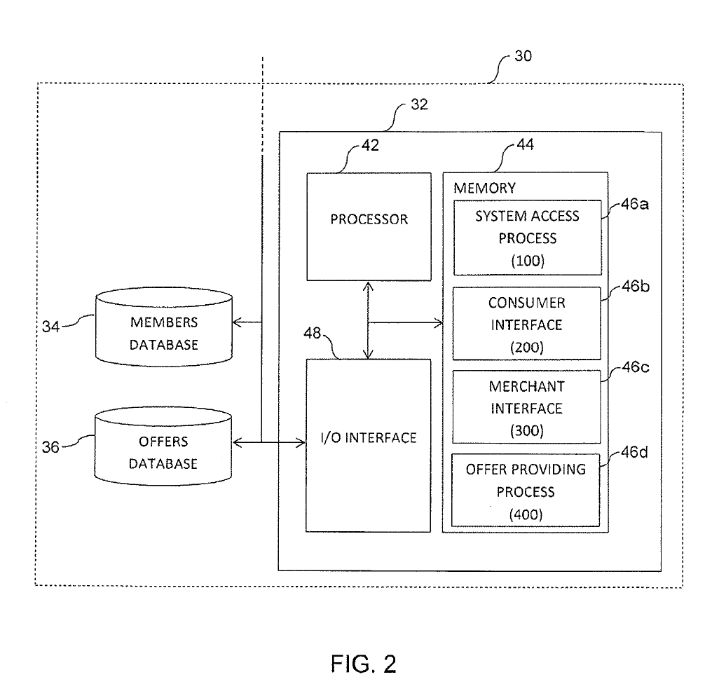

Referring now to FIG. 2, the offers server 32 includes a processor 42 with an associated memory 44 having stored therein processor executable instructions 46a, 46b, 46c and 46d for configuring the processor 42 to perform, respectively, the system access process 100, the consumer interface process 200, the merchant interface process 300 and the offer providing process 400, all of which will be detailed further below. The offers server 32 further includes an input/output (I/O) interface 48, which may include a web server, for communication with the members database 34, the offers database 36, the network 20 and the computing devices 12.

It is to be understood that in alternative embodiments the consumer interface process 200 and/or the merchant interface process 300 may be implemented or executed on the computing device 12 or a third party device (i.e. server, website, etc.).

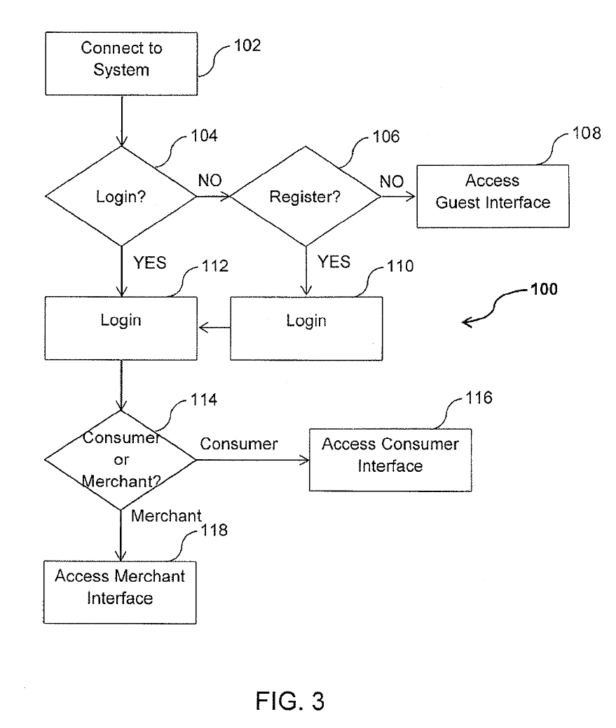

Referring to FIG. 3, there is shown a flow diagram of the process 100 of accessing the system for providing transportation or other activity based offers 30. Steps of the process 100 are indicated by blocks 102 to 118.

The process 100 starts at block 102 where a user connects to system for providing transportation or other activity based offers 30 using a computing device 12. This may be done via an internet browser or an app.

At block 104, the process 100 verifies if the user wishes to login into the system for providing transportation or other activity based offers 30. If so, the process 100 proceeds to block 112, if not, it proceeds to block 106.

Then, at block 106, process 100 verifies if the user wishes to register as a member of the system for providing transportation or other activity based offers 30. If so, the process 100 proceeds to block 110, if not, it proceeds to block 108 where the user is given access to a guest interface, which is essentially the consumer interface provided with a limited set of functionalities such as, for example, viewing potential offers with limited information. It is to be understood that the guest interface may be optional and/or the set of functionalities customizable. It is also to be understood that in an alternative embodiment consumers may use the system for providing transportation or other activity based offers 30 without having to be registered members.

At block 110, the user registers as a consumer or a merchant and becomes a registered member by entering required information such as, for example, name, email, member identification (e.g. nickname), password, etc., as well as, optionally or depending on the type of member (i.e. consumer or merchant), payment information such as credit card number, direct deposit information, Paypal™ account, Interact transaction information, loyalty point card number, etc., which information is saved in the members database 34. It is to be understood that various verifications may be executed by the system for providing transportation or other activity based offers 30 in order to validate the information provided by the registering user. The process 100 then proceeds to block 112.

At block 112, the user logs into the system for providing transportation or other activity based offers 30 with its member identification and password, which are validated using the members database 36.

Once the identification and password of the member are validated the process 100 verifies, at block 114, if the member is a consumer, in which case it proceeds to block 116 where the member is given access to the consumer interface, or a merchant, in which case it proceeds to block 118 where the member is given access to the merchant interface.

### Consumer Interface

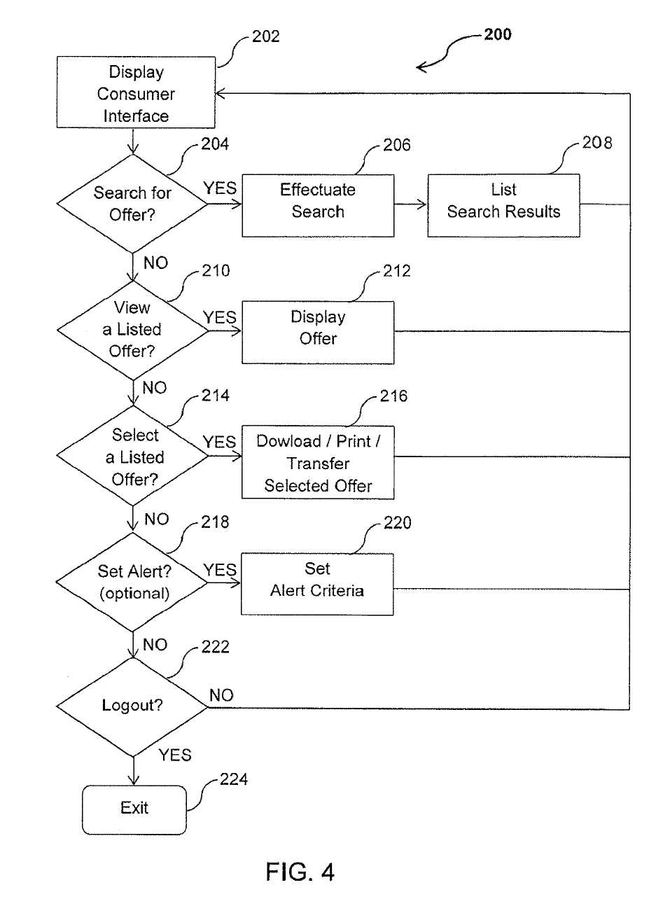

Referring now to FIG. 4, there is shown a flow diagram of the consumer interface process 200 of a user accessing the consumer interface of the system for providing transportation or other activity based offers 30 at block 116 of process 100 of FIG. 3. Steps of process 200 are indicated by blocks 202 to 224.

The process 200 starts at block 202 where the consumer interface is displayed, listing the functions available to consumers, for example searching the offers database 36 for available offers, display or select an offer, set an alert for a desired offer, etc. Optionally, the various options may be limited for guest users.

At block 204, the process 200 verifies if the consumer has selected the search option and if so, effectuates, at block 206, the search according to the consumer's end destination (either provided by the consumer or through a GPS functionality of a computing device 12 used by the consumer) and, optionally, desired search criteria such as, for example, conversion ratio range of values, establishment maximum distance from end destination, category of merchant establishment (e.g. restaurant, clothing store, gym, etc.), and displays the offers resulting from the search at block 208. In an alternative embodiment, the consumer may be provided with various selectable parameter filters for narrowing it search. The process 200 then proceeds back to block 202.

At block 210, the process 200 verifies if the consumer has selected a listed offer to be viewed and if so, displays, at block 212, the details of the selected offer. In an alternative embodiment, the offers identified by the search may be displayed as pins onto a map showing the end destination, in which case each pin is selectable so as to display the offer details. In a further embodiment, in the case of transportation based offers, if the consumer has entered one or more transportation mode, the selection of a displayed pin also displays an estimate of the transportation cost likely incurred to reach the end destination. The process 200 then proceeds back to block 202.

At block 214, the process 200 verifies if the consumer has selected a listed offer and if so, a block 216, the system for providing transportation or other activity based offers 30 allows the consumer to download or print the offer, and, optionally, transfer the offer to another consumer (i.e. via email, text, social networking application, etc.). Optionally, the merchant who created the offer may be informed that its offer has been selected and may also be provided information about the consumer who selected the offer. The process 200 then proceeds back to block 202.

At block 218, optionally, the process 200 verifies if the consumer has selected to set an alert and if so, a block 220, the criteria of a desired offer are set such that the system for providing transportation or other activity based offers 30 alerts the consumer (i.e. via email, text, social networking application, etc.) when a matching offer is created and added to the offers database 36. Optionally, the merchant who created the corresponding offer may also be alerted of the match. The process 200 then proceeds back to block 202.

Finally, at block 222, the process 200 verifies if the consumer has selected to logout and if so, it exits the system for providing transportation or other activity based offers 30 at block 224, if not, the process 200 proceeds back to block 202.

It is to be understood that other functionalities, such as editing a member's profile, help, email, password modification, etc., as commonly known in the art, may also be provided.

### Merchant Interface

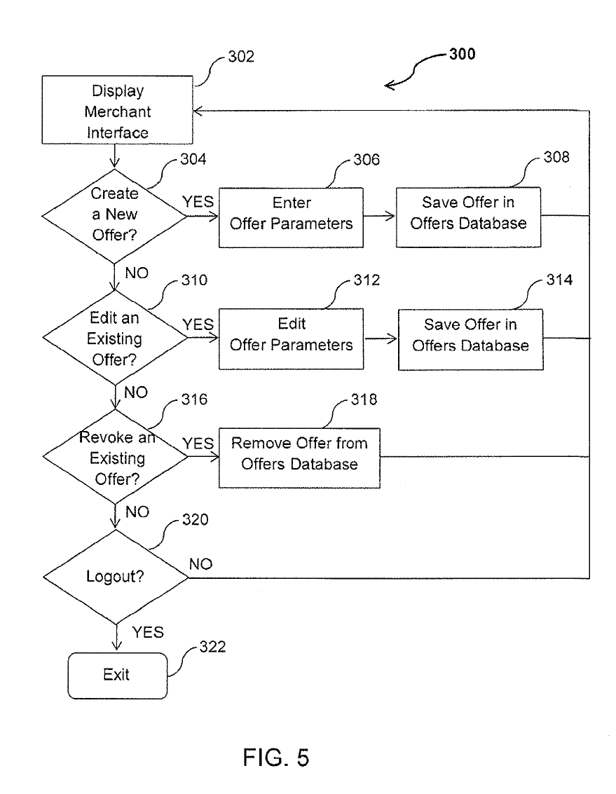

Referring to FIG. 5, there is shown a flow diagram of the merchant interface process 300 of a user accessing the merchant interface of the system for providing transportation or other activity based offers 30 at block 118 of process 100 of FIG. 3. Steps of the process 300 are indicated by blocks 302 to 322.

The process 300 starts at block 302 where the merchant interface is displayed, listing the functions available to merchants, for example creating a new offer, editing or deleting an existing offer, etc.

At block 304, the process 300 verifies if the merchant has selected to create a new offer and if so, proceeds to block 306, where the parameters of the offer are entered. The parameters include the conversion ration and other parameters such as qualified transportation modes, promotion period, etc. In an alternative embodiment, the merchant may also set parameters that control the circumstances under which its offer is:
displayed to a consumer (for example, it may be that a merchant is a restaurant only wants to be displayed to consumers who have used and redeemed offers at least 10 or more times; this can also serve to reward consumers who are power-users of the system); and/or
redeemed by a consumer (for example, all redemptions must occur within 24 hours of the issuance of the offer to the consumer).

Then, at block 308, the system for providing transportation or other activity based offers 30 stores the offer parameters in the offers database 36. The process 300 then proceeds back to block 302.

At block 310, the process 300 verifies if the merchant has selected to edit an existing offer and if so, proceeds to block 312, where one or more of the offer's parameters are edited. Then, at block 314, the system for providing transportation or other activity based offers 30 stores the updated offer parameters in the offers database 36. The process 300 then proceeds back to block 302.

At block 316, the process 300 verifies if the merchant has selected to revoke an existing offer (for example, if a restaurant realizes two hours after the commencement of a four-hour promotion period that it is unexpectedly full) and if so, proceeds to block 318, where the system for providing transportation or other activity based offers 30 removes the offer from the offers database 36 at which time the offer ceases to be displayed by the consumer interface process 200. The process 300 then proceeds back to block 302.

Finally, at block 320, the process 300 verifies if the merchant has selected to logout and if so, it exits the system for providing transportation or other activity based offers 30 at block 322, if not, the process 300 proceeds back to block 302.

The merchant interface process 300 can be run, for example, on a goods or services provider website, for example a transportation provider, having a section where it displays, after a consumer has purchased a transportation ticket, a specific list of offers from merchants prepared to offset the cost of the ticket price paid by the consumer to the transportation provider.

In an alternative embodiment, an aggregator website can “aggregate” (e.g. Kayak™) the best offers based on criteria a consumer inserts in its search engine. These criteria can be based on geographic location, radius from an end destination selected by the consumer, minimum conversion ratio, maximum conversion ratio limit, time limit as to issuance and redemption, etc.

It is to be understood that other functionalities, such as editing a member's profile, help, email, password modification, etc., as commonly known in the art, may also be provided.

The system for providing transportation or other activity based offers 30 may enable merchants or a category of merchants to provide offers having a plurality of associated conversion ratios depending on, amongst other and without limitation, time period, attributes of intended offer recipients, qualified transportation modes and/or other. For example:
the merchant may be permitted to provide, for example, a first conversion ratio for one or more qualified transportation modes (for example ground transportation) and a second conversion ratio for other qualified transportation modes (for example air transportation, water transportation, etc.);
the merchant may be permitted to provide a first conversion ratio for a first portion of the promotion period and a second conversion rate a second portion of the promotion period;
the merchant may be permitted to provide a specific conversion ratio for a limited scope of goods and/or services;
the merchant may be permitted to provide a first conversion ratio to the general public, and a second conversion ratio to consumers who, for example, have patroned the establishment of the merchant in the past; and/or hold a particular status under an existing loyalty program of the merchant; and/or hold a particular status in relation to the system for providing transportation or other activity based offers 30 (for example, if the consumer is a member who is a premium account holder);
the merchant may be permitted to provide a first conversion ratio for the general public and a second conversion ratio (for example lower than the first conversion ratio) for consumers who enter a promotion code into the system for providing transportation or other activity based offers 30; and/or
the merchant may be permitted to provide a first conversion ratio for consumers having used a certain transportation provider and a second conversion ratio (for example higher than the first conversion ratio) for consumers having used other transportation providers.

The system for providing transportation or other activity based offers 30 may also allow the merchant to place a limit on the number of offers available for individual promotion periods as well as limit the goods and/or services in relation any offer.

The system for providing transportation based offers 30 may also allow the merchant to place a limit on, amongst other, the number of offers available for individual promotion periods or the aggregate total amount of transportation costs covered by the merchant, as well as limit the goods and/or services in relation any offer, in each case with an ability to vary same for each of its locations (if it operates more than one location).

In an alternative embodiment, the system for providing transportation based offers 30 may charge the merchant an amount, such as for example and without limitation, a membership fee and/or a fixed per-transaction fee or sum owing under a revenue share arrangement. For example, the merchant may be charged $0.25 every time its establishment comes up on a search by a consumer and an additional $2.00 every time an offer is presented to the merchant. It is to be understood that other amounts may be charged or that the amounts may vary according to various parameters such as the category of merchant, a discount amount, etc.

In a further alternative embodiment, the system for providing transportation or other activity based offers 30 may provide for the registration of premium members (on the consumer side) that pay to have access to commercial establishments that have provided a filter pursuant to which they will provide a first offer to the general public and, in parallel, a second offer to premium members only (for example having a lower conversion ratio). A premium member can be, for example, a member who pays a monthly membership fee, a power-user (for example the member has redeemed offers a predefined minimum number of times) or has achieved a specific “rank” or a specific number of points under its own or an associated loyalty program. Conversely, on the merchant side, for example, a merchant may provide an offer only to premium members, without also providing an offer to the general public, in exchange for a fee.

### Offer Providing Process

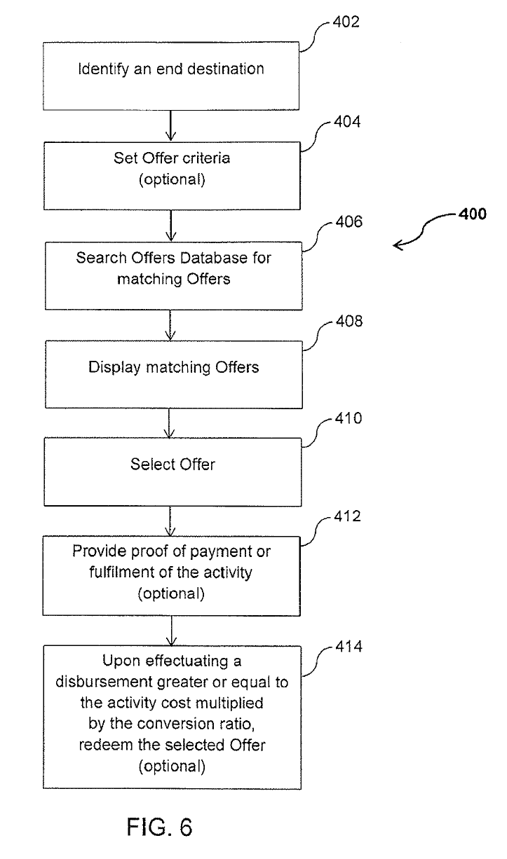

Referring now to FIG. 6, there is shown a flow diagram of the offer providing process 400. Steps of process 400 are indicated by blocks 402 to 414.

The process 400 starts at block 402 where an end destination of the consumer is identified, or example using the consumer interface process 200 of FIG. 3, or through a GPS functionality of the computing device 12 used by the consumer. This could be a current position of the consumer or a desired destination.

Then, at block 404, optionally, desired offer criteria may be established, for example type of goods/services offered by the merchant, wheelchair accessibility, languages spoken, etc.

At block 406, a search is effectuated in order to identity offers in the offers database 36 that are available at the end destination (or at a given distance from said end destination) and, optionally, that meet the desired offer criteria and, at block 408, the identified matching offers are displayed to the consumer.

At block 410, a displayed offer is selected and downloaded, printed or, optionally, transferred to another consumer (i.e. via email, text, social networking application, etc.)

Optionally, at blocks 412 and 414, the system for providing transportation or other activity based offers 30 may be provided with proof of payment of the activity cost (for example payment of the transportation cost) or proof of fulfillment of the activity and then, upon the consumer effectuating a disbursement at the merchant's establishment greater or equal to the activity cost (in the case of the fulfilment of an activity, the activity cost may be a direct monetary cost, an equivalent monetary cost or an assigned monetary cost) multiplied by the conversion ratio, the offer is redeemed (i.e. the discount, reward, points or gift certificate is applied/provided). The redeeming of the offer can be performed by the merchant or automatically by the system for providing transportation or other activity based offers 30. In an alternative embodiment, all transfer of money, awarding of points, issuing of certificates, etc., may be accomplished by the system for providing transportation or other activity based offers 30.

In an alternative embodiment, if a consumer visits a merchant's establishment but does not satisfy the conversion ratio the reward of the offer (discount, reward points, goods, services, gift certificates, etc.) is prorated such that it is reduced.

### Sample Scenarios

In a first illustrative scenario, a participant merchant is a hotel, which creates a new offer In the system for providing transportation or other activity based offers 30 by setting associated parameters through the merchant interface process 300. The parameters include the following:
conversion ratio of 3.0;
promotion period: Wednesday, Apr. 1, 2015 at 9.00 a.m. to Thursday, Apr. 2, 2015 at 9.00 a.m.;
redemption period: 24 hours;
qualified transportation mode: airplane only; and
recurrence: no.

Using the above parameters, this means that the merchant may deduct, from the price of its goods and/or services which it charges to a consumer, a sum equal to the trip amount associated with the airfare of the consumer, provided the consumer spends an amount with the merchant that is not less than the value obtained by multiplying the trip amount by the conversion ratio, i.e. 3.0. Otherwise put, the merchant will offset from the consumer's hotel invoice an amount which corresponds to the trip amount of the consumer's airfare provided the consumer spends $3.00 at the merchants establishment for every $1.00 of the trip amount paid for air travel. Thus, if the air fare is $1,000, in this example the discount amount of the offer is $1,000 and the minimum spend is $3,000. However, to benefit from the discount amount the consumer must, amongst others, redeem the merchant's offer at the merchant's establishment within 24 hours of the moment the offer was issued to the consumer. Thus, if the offer is issued to a consumer at 8.00 a.m. on Apr. 2, 2015, even if the promotion period ends at 9.00 a.m. on Apr. 2, 2015, the offer holder can claim the discount amount at any time within the 24 hour period commencing as of 8.00 a.m. on Apr. 2, 2015.

In this example, the system for providing transportation or other activity based offers 30 will only display this offer between Apr. 1, 2015 at 9.00 a.m. and Apr. 2, 2015 at 9.00 a.m. (to the extent the merchant who created the offer falls within applicable search parameters). Because no recurrence is provided in this example, this means that this offer can only be issued to consumers on this specific Wednesday and Thursday. However, if the merchant had provided that it was recurrent up to and until Jan. 1, 2016, this deal would have been offered to consumers not only April 1 to Apr. 2, 2015, but on each and every Wednesday and Thursday up to and until Jan. 1, 2016, inclusively.

In the preceding example, the merchant provided for a qualified transportation mode of airplane only. However, if it had provided, for example, taxi and airplane only, this means it would be prepared to cover up to a maximum of the cost of a taxi trip or an airplane trip.

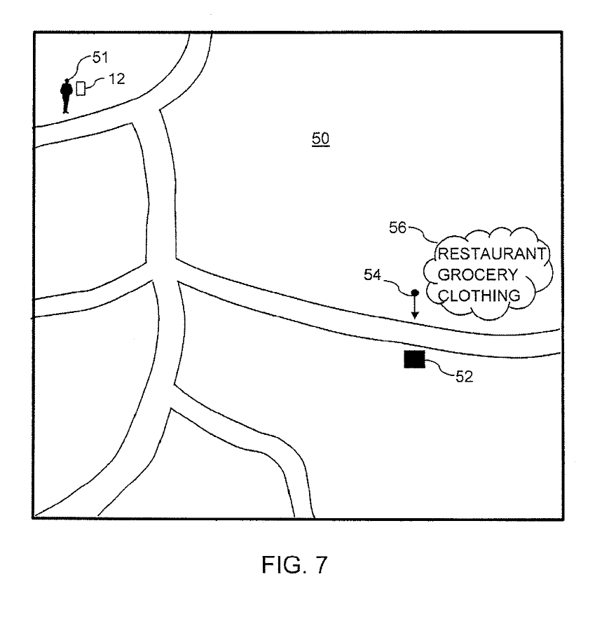

In a second illustrative scenario, with reference to FIG. 7, a consumer 51 has a meeting scheduled at location 52 (i.e. end destination). The consumer 51 uses its computing device 12 (for example a smart phone) to access the consumer interface process 200 in order to verify which restaurants are located near its end destination. The consumer 51 enters the end destination and “restaurant” as a search parameter. A pin 54 then drops onto a map 50 showing an identified merchant's establishment (i.e. restaurant). Alternatively, if the consumer enters one or more transportation mode (such as, for example, bus or taxi), he or she may also be provided an estimate of the transportation cost likely incurred to reach the merchant's establishment.

Alternatively, if the consumer has not specified the category of the desired merchant it is looking for (i.e. restaurant), the consumer interface 200 may allow him or her to narrow its search via a selectable merchant category indicator 56. Further indicators may include, for example, type of cuisine, hours of opening, prices, wheelchair accessibility, etc.

Assuming in this example that the merchant (i.e. restaurant), provided offer parameters as follows:
conversion ratio of 3.0;
promotion period: Dec. 1, 2014 at 9.00 a.m. to Dec. 2, 2014 at 9.00 a.m.;
redemption period: 24 hours;
qualified transportation mode: bus and taxi only; and
recurrence: no.

In this example, the system for providing transportation or other activity based offers 30 will only display the offer of this restaurant to an the consumer between Dec. 1, 2014, 9.00 a.m. and Dec. 2, 2014 at 9.00 a.m. This is the only time when the option of this restaurant, or its offer, will be displayed. Because no recurrence is provided in this example, this means that this offer can only be issued to consumers during the promotion period of Dec. 1, 2014 at 9.00 a.m. up to and until Dec. 2, 2014 at 9.00 a.m. However, if the restaurant in this example had provided that there was a recurrence until Jan. 1, 2015, this offer would have been offered to consumers not only December 1 to December 2, but on each and every period of time commencing on Monday at 9.00 a.m. and ending Tuesday, 9.00 a.m. up to and until Jan. 1, 2015, inclusively.

Assume the consumer takes a taxi to go to its business meeting (i.e. end destination 52) during the promotion period, which is to say after Dec. 1, 2014 at 9.00 a.m. but before Dec. 2, 2014, at 9.00 a.m., and selects the offer identified by pin 54, when he or she arrives to the end destination 52, because he or she paid the transportation cost in relation to a qualified transportation mode, he or she will have the cost of its meal reduced by the transportation cost provided the cost of such meal, before gratuities and taxes, is equal to at least three times the transportation cost.

For example, if the transportation cost was $10 and the meal cost is $30 before tip and gratuities, because the consumer has satisfied the conversion ratio by generating purchases which are equal to not less than the transportation cost multiplied by the conversation ratio, then an amount corresponding to the transportation cost is deducted from the consumer's meal bill. Consequently, the consumer only pays the restaurant $20 plus tip and gratuities calculated on pre-deduction amount.

If the consumer does not satisfy the conversion ratio (in this example, if, for instance, the final restaurant bill is $15 before tip and gratuities) the discount may be prorated such that a reduced amount is offset from the bill (for example, since $15 is half the conversion ratio multiplied by the transportation cost, the merchant could offer a discount equal to half the transportation cost), or no discount may be provided at all.

Although throughout the above disclosure reference is made to transport related activities, the herein disclosed system and method may, in alternative embodiments, also apply to health or goodwill related activities. In these alternative embodiments the transportation fee may be replaced by an activity cost such as a direct monetary cost, an equivalent monetary cost and an assigned monetary cost. In the case of health related activities the activity cost may be a monetary value assigned as a function of the number of steps taken, stairs climbed, distance walked, number of repetitions of a given exercise, etc., while in the case of goodwill related activities the activity cost may be the amount of a monetary donation or a monetary value assigned as a function of the value of donated goods, services or time to a charity or registered non-profit organization. The applicable health or goodwill related activities and activity costs may be set by the merchant and/or the system for providing transportation or other activity based offers 30.

It is to be understood that even though throughout the above disclosure reference is made to the “dollar” as the currency, the system and method described herein can be used with any currency (including, without limitation, cryptocurrency) or unit of value.

Although the present disclosure has been described with a certain degree of particularity and by way of an illustrative embodiment and examples thereof, it is to be understood that the present disclosure is not limited to the features of the embodiments described and illustrated herein, but includes all variations and modifications within the scope and spirit of the disclosure as hereinafter claimed.

What is claimed is:

1. A method for providing a consumer with at least one merchant offer, the method comprising:
identifying an end destination of the consumer, the end destination having an associated activity and activity cost;
providing to the consumer the at least one merchant offer based on the end destination, the at least one merchant offer having an associated reward and an associated conversion ratio;
prompting the consumer to select one of the provided at least one merchant offer; and
upon proof of fulfilment of the activity and disbursement in goods and/or services of the merchant by the consumer greater or equal to the activity cost multiplied by the conversion ratio of the selected merchant offer, providing the reward associated with the selected merchant offer to the consumer.

2. A method in accordance with claim 1, wherein the activity cost is selected from a group consisting of a direct monetary cost, an equivalent monetary cost and an assigned monetary cost.

3. A method in accordance with either of claims 1 or 2, wherein the reward is selected from a group consisting of discounts, reward points, goods, services and gift certificates.

4. A method in accordance with any of claims 1 to 3, wherein the reward has a value equal to the activity cost.

5. A method in accordance with any of claims 1 to 4, wherein the activity is a transport related activity.

6. A method in accordance with claim 5, wherein the activity cost is a transportation fee and the fulfilment of the activity is the payment of the transportation fee.

7. A method in accordance with either of claims 5 or 6, wherein the transport related activity has an associated type and the step of providing to the consumer the at least one merchant offer is further based on the transport related activity type.

8. A method in accordance with claim 7, wherein the transport related activity type is selected from a group consisting of limousine, taxi, for-hire vehicle, self-driving vehicle, bus, train, tram, metro, boat, ferry, hovercraft, helicopter and airplane.

9. A method in accordance with any of claims 1 to 4, wherein the activity is a health related activity.

10. A method in accordance with claim 9, wherein the health related activity has an associated type and the step of providing to the consumer the at least one merchant offer is further based on the health activity type.

11. A method in accordance with any of claims 1 to 4, wherein the activity is a goodwill related activity.

12. A method in accordance with claim 11, wherein the goodwill related activity has an associated type and the step of providing to the consumer the at least one merchant offer is further based on the goodwill activity type.

13. A method in accordance with any of claims 1 to 12, wherein the step of providing to the consumer the at least one merchant offer is based on the distance from the end destination to an establishment of the merchant.

14. A method in accordance with any of claims 1 to 13, wherein each of the at least one merchant offer has an associated promotion period and the step of providing the reward to the consumer is performed only if the disbursement in goods and/or services of the merchant by the consumer is effectuated within the promotion period.

15. A method in accordance with any of claims 1 to 14, wherein the step of providing to the consumer the at least one merchant offer is further based on at least one consumer selectable criteria selected from a group consisting of a conversion ratio range of values, a merchant's establishment maximum distance from the end destination, a service offered by the merchant, a goods offered by the merchant, a category of merchant, the activity cost an activity type.

16. A method in accordance with any of claims 1 to 15, further comprising the step of providing the selected merchant offer to a substitute consumer and wherein the disbursement in goods and/or services of the merchant is effectuated by the substitute consumer and the reward associated with the selected merchant offer is provided to the substitute consumer.

17. A system for providing a consumer using a first computing device with at least one merchant offer, the system comprising:
a database;
a processor in communication with the database, the processor having a first interface for communication with the first computing device and being configured to:
receive an end destination from the first computing device, the end destination having an associated activity and activity cost;
display to the consumer through the first interface the at least one merchant offer from the database, the merchant offer being based on the end destination and having an associated reward and an associated conversion ratio;
prompt the consumer through the first interface to select one of the displayed at least one merchant offer; and
provide the selected merchant offer to the consumer.

18. A system in accordance with claim 17, wherein the processor is further configured to:
verify payment of the activity cost and disbursement in goods and/or services of the merchant by the consumer greater or equal to the activity cost multiplied by the conversion ratio of the selected merchant offer; and
provide the reward associated with the selected merchant offer to the consumer.

19. A system in accordance either of claims 17 or 18, wherein the first computing device includes a global positioning system functionality automatically providing the end destination to the processor.

20. A system in accordance with any of claims 17 to 19, wherein the activity cost is selected from a group consisting of a direct monetary cost, an equivalent monetary cost and an assigned monetary cost.

21. A system in accordance with any of claims 17 to 20, wherein the reward is selected from a group consisting of discounts, reward points, goods, services and gift certificates.

22. A system in accordance with any of claims 17 to 21, wherein the reward has a value equal to the activity cost.

23. A system in accordance with any of claims 17 to 22, wherein the activity is a transport related activity.

24. A system in accordance with claim 23, wherein the activity cost is a transportation fee and the fulfilment of the activity is the payment of the transportation fee.

25. A system in accordance with either of claims 23 or 24, wherein the transport related activity has an associated type and the processor is further configured to provide to the consumer the at least one merchant offer based on the transport related activity type.

26. A system in accordance with claim 25, wherein the transport related activity type is selected from a group consisting of limousine, taxi, for-hire vehicle, self-driving vehicle, bus, train, tram, metro, boat, ferry, hovercraft, helicopter and airplane.

27. A system in accordance with any of claims 17 to 22, wherein the activity is a health related activity.

28. A system in accordance with claim 27, wherein the health related activity has an associated type and the processor is further configured to provide to the consumer the at least one merchant offer based on the health activity type.

29. A system in accordance with any of claims 17 to 22, wherein the activity is a goodwill related activity.

30. A system in accordance with claim 29, wherein the goodwill related activity has an associated type and processor is further configured to provide to the consumer the at least one merchant offer based on the goodwill activity type.

31. A system in accordance with any of claims 17 to 30, wherein the processor is further configured to provide the at least one merchant offer based on the distance from the end destination to an establishment of the merchant.

32. A system in accordance with any of claims 17 to 31, wherein each of the at least one merchant offer has an associated promotion period and the processor is further configured to provide the reward only if the disbursement in goods and/or services of the merchant by the consumer is effectuated within the promotion period.

33. A system in accordance with any of claims 17 to 32, wherein the processor is further configured to provide the at least one merchant offer based on at least one consumer selectable criteria provided by the first interface, the at least one consumer selectable criteria being selected from a group consisting of a conversion ratio range of values, a merchant's establishment maximum distance from the end destination, a service offered by the merchant, a goods offered by the merchant, a category of merchant, the activity cost an activity type.

34. A system in accordance with any of claims 17 to 33, wherein the processor is further configured to allow the consumer to provide the selected merchant offer to a substitute consumer through the first interface and wherein the disbursement in goods and/or services of the merchant is effectuated by the substitute consumer and the reward associated with the selected merchant offer is provided to the substitute consumer.

35. A system in accordance with any of claims 17 to 34, further comprising a second interface for communication with a second computing device, the processor being further configured to:
prompt a merchant to enter through the second interface a new merchant offer having a new associated reward and a new associated conversion ratio;
store the new merchant offer in the database.

36. A system in accordance with claim 35, wherein the processor is further configured to prompt the merchant to enter through the second interface a new promotion period associated with the new merchant offer.

37. A system in accordance with either of claims 35 or 36, wherein the processor is further configured to prompt the merchant to enter through the second interface at least one parameter associated with the new merchant offer selected from the group consisting of a maximum amount of activity costs the merchant is prepared to assume, a type of activity for which the new offer is valid, a type of goods for which the new offer is valid and a type of service for which the new offer is valid, and wherein the processor is further configured to provide to the consumer the at least one merchant offer based on the at least one parameter.
